(19) United States
(12) Patent Application Publication
(10) Pub. No.: US 2019/0165420 A1
(43) Pub. Date: May 30, 2019

(54) MAGNESIUM SECONDARY CELL, AND NONAQUEOUS ELECTROLYTE FOR MAGNESIUM SECONDARY CELL

(71) Applicant: NATIONAL INSTITUTE OF ADVANCED INDUSTRIAL SCIENCE AND TECHNOLOGY, Tokyo (JP)

(72) Inventors: Hajime MATSUMOTO, Ikeda (JP); Rie OOYABU, Ikeda (JP); Keigo KUBOTA, Ikeda (JP); Kazumi TAKEDA, Ikeda (JP)

(73) Assignee: NATIONAL INSTITUTE OF ADVANCED INDUSTRIAL SCIENCE AND TECHNOLOGY, Tokyo (JP)

(21) Appl. No.: 16/081,788

(22) PCT Filed: Feb. 28, 2017
(86) PCT No.: PCT/JP2017/007995

§ 371 Date: Feb. 15, 2019

(30) Foreign Application Priority Data
Mar. 1, 2016 (JP) 2016-038845

(51) Int. Cl. H01M 10/0569; H01M 10/054; H01M 10/0568

(52) U.S. Cl. CPC H01M 10/0569; H01M 2300/0037; H01M 10/0568; H01M 10/054

(57) ABSTRACT

The present invention provides a magnesium secondary cell comprising a positive electrode, a negative electrode releasing magnesium ions, and a nonaqueous electrolyte. The nonaqueous electrolyte comprises a solvent and a magnesium sulfonamide salt represented by formula (I) below,

Mg[X¹—SO₂—N—SO₂—X²]₂ (I)

wherein X¹ and X² are identical or different and each represents CₚF₂ₚ₊₁, or X¹ and X² are taken together to represent C_{q}F_{2q}, wherein p is 0, 1, 2, or 3, and q is 2, 3, or 4. The solvent is a mixed solvent comprising a sulfone-based solvent and an ether- or thioether-based solvent, or the solvent is a solvent comprising a sulfone moiety and an ether or thioether moiety.

### TECHNICAL FIELD

The present invention relates to a magnesium secondary cell and a nonaqueous electrolyte for magnesium secondary cells.

### BACKGROUND ART

Magnesium secondary cells, which have a high theoretical capacity density and abundant resources, and which are highly safe, are expected to find practical application as cells that are more excellent than lithium secondary cells. Compared with monovalent lithium ions, however, divalent magnesium ions have a strong interaction, and are unlikely to diffuse in the solid phase.

Patent Literature 1 discloses an electrolyte containing magnesium ions, a halide, and a monovalent anion; and TFSA⁻ ((CF₃SO₂)₂N⁻) etc. are listed as examples of the monovalent anion. Further, electrolytes containing a Grignard reagent (alkyl magnesium halide), magnesium alkoxide, or the like are also known (Patent Literature 2 and 3); however, these electrolytes cannot produce cells with a high voltage of 2 V or more due to their low oxidation resistance.

### CITATION LIST

### Patent Literature

PTL 1: U.S. Pat. No. 8,951,676

PTL 2: JP2014-186940A

PTL 3: JP2015-115233A

### SUMMARY OF INVENTION

### Technical Problem

An object of the present invention is to provide a magnesium secondary cell that is capable of operating a high-voltage cell, and a nonaqueous electrolyte for magnesium secondary cells.

### Solution to Problem

The present invention provides the following magnesium secondary cells and nonaqueous electrolyte for magnesium secondary cells.

1. A magnesium secondary cell comprising a positive electrode, a negative electrode releasing magnesium ions, and a nonaqueous electrolyte,

the nonaqueous electrolyte comprising a solvent and a magnesium sulfonamide salt represented by formula (I) below,

Mg[X¹—SO₂—N—SO₂—X²]₂ (I)

wherein X¹ and X² are identical or different and each represents CₚF₂ₚ₊₁, or X¹ and X² are taken together to represent C_{q}F_{2q}, wherein p is 0, 1, 2, or 3, and q is 2, 3, or 4,

the solvent being a mixed solvent comprising a sulfone-based solvent and an ether- or thioether-based solvent, or the solvent being a solvent comprising a sulfone moiety and an ether or thioether moiety.

2. The magnesium secondary cell according to Item 1, wherein the sulfone-based solvent is represented by formula (II) below,

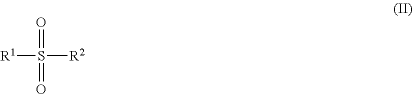

wherein R¹ and R² are identical or different and each represents a C₁₋₄ alkyl group.

3. The magnesium secondary cell according to Item 1 or 2, wherein the ether- or thioether-based solvent is represented by formula (III) below,

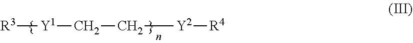

wherein Y¹ and Y² are identical or different and each represents O or S, R³ and R⁴ are identical or different and each represents methyl or ethyl, and n is an integer of 1 to 4.

4. The magnesium secondary cell according to any one of Items 1 to 3, wherein the solvent comprising a sulfone moiety and an ether or thioether moiety is represented by formula (IV) below,

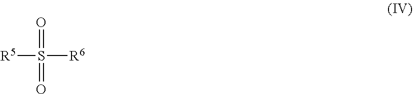

wherein R⁵ and R⁶ are identical or different and both represent a group represented by —R⁷—(O—CH₂CH₂—)ₘ—OR⁸—, or one represents a C₁₋₄ alkyl group and the other represents a group represented by R⁷—(O—CH₂CH₂—)ₘ—OR⁸, wherein m is an integer of 0 to 2, R⁷ represents CH₂ or CH₂CH₂, and R⁸ represents methyl or ethyl.

5. A nonaqueous electrolyte for magnesium secondary cells wherein a mixed solvent comprising a sulfone-based solvent and an ether- or thioether-based solvent, or a solvent comprising a sulfone moiety and an ether or thioether moiety comprises a magnesium sulfonamide salt represented by formula (I) below,

Mg[X¹—SO₂—N—SO₂—X²]₂ (I)

wherein X¹ and X² are identical or different and each represents CₚF₂ₚ₊₁, or X¹ and X² are taken together to represent C_{q}F_{2q}, wherein p is 0, 1, 2, or 3, and q is 2, 3, or 4.

### Advantageous Effects of Invention

According to the present invention, the use of a nonaqueous electrolyte containing a specific solvent can reduce the overvoltage, and obtain a high-voltage magnesium secondary cell.

### BRIEF DESCRIPTION OF DRAWINGS

FIG. 1 shows the results of cyclic voltammograms of magnesium secondary cells using known-solvent (DME, G3, GBL, EiPSL, or AN)-containing nonaqueous electrolytes. The experiment was conducted in a glove box filled with an Ar gas. WE: Pt flag, CE: Mg ribbon, RE: Ag wire, sample tube.

FIG. 2 shows a comparison of cyclic voltammograms of magnesium secondary cells using known-solvent (G3 or EiPSL)-containing nonaqueous electrolytes at 25° C. and 95° C. The experiment was conducted in a glove box filled with an Ar gas. WE: Pt flag, CE: Mg ribbon, RE: Ag wire, sample tube.

FIG. 3 shows a cyclic voltammogram of a magnesium secondary cell containing 0.5 M MgTFSA₂ and a mixed solvent of ethylmethylsulfone:diglyme=1:1. Redox occurs at a potential very close to the theoretical potential without containing additives, additive salts, and halogens.

FIG. 4 shows deposition and re-elution behavior in a mixed solvent. Deposition: I=−20 μA (3 min), rest 1 min, Stripping: I=+20 μA (cutoff 0.0 V vs Ag Q.R.E.), rest: 1 min.

FIG. 5 shows the cyclic voltammograms of magnesium secondary cells using solvent-containing nonaqueous electrolytes. Measurement conditions: T=25° C., 50 mV/s, WE: Pt, CE: Mg, RE: Ag Q.R.E. 0.5 M Mg[TFSA]₂, Glymes: G1, G2, G3, and G4, Sulfone: SLxy [(CₓH₂ₓ₊₁) (C_{y}H_{2y+1}) SO₂].

FIG. 6 shows bipolar operation (CR2032, AZ31) using a V₂O₅ model positive mixture. Separator: Whatman GF/A 200 μm, V₂O₅ mixture (V₂O₅:(KB+VGCF):PI=90:(3+2):5) 0.01 C, negative electrode: AZ31.

### DESCRIPTION OF EMBODIMENTS

The nonaqueous electrolyte for magnesium secondary cells used in the present invention is obtained by dissolving in a solvent a magnesium sulfonamide salt represented by the general formula (I),

Mg[X¹—SO₂—N—SO₂—X²]₂ (I)

wherein X¹ and X² are identical or different and each represents CₚF₂ₚ₊₁, or X¹ and X² are taken together to represent C_{q}F_{2q}, wherein p is 0, 1, 2, or 3, and q is 2, 3, or 4. Although a sulfone-based solvent or an ether- or thioether-based solvent used alone as a solvent increases the overvoltage, a mixed solvent containing a sulfone-based solvent and an ether- or thioether-based solvent, or a solvent containing a sulfone moiety and an ether or thioether moiety remarkably reduces the overvoltage, which enables the obtainment of high voltage that magnesium secondary cells generally have.

p is 0, 1, 2, or 3, preferably 0, 1, or 2, more preferably 0 or 1, and even more preferably 1.

q is 2, 3, or 4, preferably 2 or 3, and more preferably 2.

X¹ and X² are preferably identical.

Examples of sulfone-based solvents include solvents represented by formula (II) below,

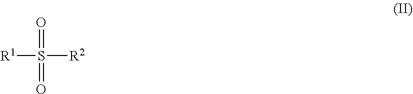

wherein R¹ and R² are identical or different and each represents a C₁₋₄ alkyl group.

Examples of C₁₋₄ alkyl groups include C₁₋₄ straight or branched alkyl groups, such as methyl, ethyl, n-propyl, isopropyl, n-butyl, isobutyl, sec-butyl, and tert-butyl.

Examples of sulfone-based solvents include dimethyl sulfone, diethyl sulfone, di-n-propylsulfone, diisopropyl sulfone, di-n-butyl sulfone, diisobutyl sulfone, di-sec-butyl sulfone, di-tert-butyl sulfone, methylethyl sulfone, methyl n-propylsulfone, methyl isopropyl sulfone, methyl n-butyl sulfone, methyl isobutyl sulfone, methyl tert-butyl sulfone, ethyl n-propyl sulfone, ethyl isopropyl sulfone, ethyl n-butyl sulfone, ethyl isobutyl sulfone, ethyl tert-butyl sulfone, n-propyl n-butyl sulfone, isopropyl n-butyl sulfone, n-propyl isobutyl sulfone, isopropyl isobutyl sulfone, n-propyl tert-butyl sulfone, isopropyl tert-butyl sulfone, and the like. The sulfone-based solvents can be used alone, or in a combination of two or more.

Examples of ether- or thioether-based solvents include solvents represented by formula (III) below,

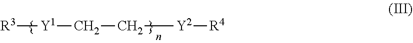

wherein Y¹ and Y² are identical or different and each represents O or S, R³ and R⁴ are identical or different and each represents methyl or ethyl, and n is an integer of 1 to 4.

It is preferable that either or both of Y¹ and Y² is/are O, and it is more preferable that Y¹═Y²═O.

R³ and R⁴ are preferably identical.

Examples of ether-based solvents include dimethoxyethane (monoglyme, G1), diethoxyethane, diethylene glycol dimethyl ether (diglyme, G2), diethylene glycol diethyl ether, triethylene glycol dimethyl ether (triglyme, G3), triethylene glycol diethyl ether, tetraethylene glycol dimethyl ether (tetraglyme, G4), tetraethylene glycol diethyl ether, and the like.

Examples of thioether-based solvents include CH₃S—CH₂CH₂—SCH₃, CH₃CH₂S—CH₂CH₂—SCH₂CH₃, CH₃S—(CH₂CH₂—S)₂CH₃, CH₃CH₂S—(CH₂CH₂—S)₂CH₂CH₃, CH₃S—(CH₂CH₂—S)₃CH₃, CH₃CH₂S—(CH₂CH₂—S)₃CH₂CH₃, CH₃S—(CH₂CH₂—S)₄CH₃, CH₃CH₂S—(CH₂CH₂—S)₄CH₂CH₃, and the like.

Examples of ether- or thioether-based solvents further include ether/thioether solvents, such as CH₃S—CH₂CH₂—OCH₃, CH₃CH₂S—CH₂CH₂—OCH₂CH₃, CH₃S—(CH₂CH₂—O)₂CH₃, CH₃CH₂S—(CH₂CH₂—O)₂CH₂CH₃, CH₃S—(CH₂CH₂—O)₃CH₃, CH₃CH₂S—(CH₂CH₂—O)₃CH₂CH₃, CH₃S—(CH₂CH₂—O)₄CH₃, and CH₃CH₂S—(CH₂CH₂—O)₄CH₂CH₃.

Examples of solvents containing a sulfone moiety and an ether or thioether moiety include solvents represented by formula (IV) below,

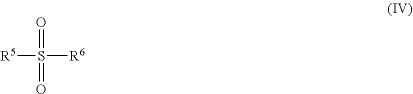

wherein R⁵ and R⁶ are identical or different and both represent the group represented by —R⁷—(O—CH₂CH₂—)ₘ—OR⁸—, or one represents a C₁₋₄ alkyl group and the other represents a group represented by R⁷—(O—CH₂CH₂—)ₘ—OR⁸. m is an integer of 0 to 2, R⁷ is CH₂ or CH₂CH₂, and R⁸ is methyl or ethyl.

m is 0, 1, or 2, preferably 0 or 1, and more preferably 0.

Examples of solvents containing a sulfone moiety and an ether or thioether moiety include CH₃SO₂CH₂CH₂OCH₃, CH₃SO₂CH₂CH₂OCH₂CH₃, CH₃CH₂SO₂CH₂CH₂OCH₃, CH₃CH₂SO₂CH₂CH₂OCH₃, CH₃SO₂(CH₂CH₂O)₂CH₃, CH₃SO₂(CH₂CH₂O)₂CH₂CH₃, CH₃CH₂SO₂(CH₂CH₂O)₂CH₃, CH₃CH₂SO₂(CH₂CH₂O)₂CH₂CH₃, CH₃SO₂(CH₂CH₂O)₃CH₃, CH₃SO₂(CH₂CH₂O)₃CH₂CH₃, CH₃CH₂SO₂(CH₂CH₂O)₃CH₃, CH₃CH₂SO₂(CH₂CH₂O)₃CH₂CH₃, CH₃SO₂(CH₂CH₂O)₄CH₃, CH₃SO₂(CH₂CH₂O)₄CH₂CH₃, CH₃CH₂SO₂(CH₂CH₂O)₄CH₃, CH₃CH₂SO₂(CH₂CH₂O)₄CH₂CH₃, CH₃OCH₂CH₂SO₂CH₂CH₂OCH₃, CH₃CH₂OCH₂CH₂SO₂CH₂CH₂OCH₂CH₃, CH₃(OCH₂CH₂)₂SO₂(CH₂CH₂O)₂CH₃, CH₃CH₂(OCH₂CH₂)₂SO₂(CH₂CH₂O)₂CH₂CH₃, CH₃(OCH₂CH₂)₃SO₂(CH₂CH₂O)₃CH₃, CH₃CH₂(OCH₂CH₂)₃SO₂(CH₂CH₂O)₃CH₂CH₃, CH₃(OCH₂CH₂)₄SO₂(CH₂CH₂O)₄CH₃, CH₃CH₂(OCH₂CH₂)₄SO₂(CH₂CH₂O)₄CH₂CH₃, and the like.

In the mixed solvent of a sulfone-based solvent and an ether- or thioether-based solvent, the mixing volume ratio of the sulfone-based solvent and the ether- or thioether-based solvent is 95:5 to 5:95, preferably 90:10 to 10:90, more preferably 80:20 to 20:80, even more preferably 70:30 to 30:70, and particularly preferably 60:40 to 40:60.

As a magnesium sulfonamide salt, Mg[(FSO₂)₂N]₂ (hereinbelow referred to as MgFSA₂) and Mg[(CF₃SO₂)₂N]₂ (hereinbelow referred to as MgTFSA₂) are preferable, and MgTFSA₂ is more preferable.

The concentration of the magnesium sulfonamide salt in the nonaqueous electrolyte is about 0.01 to 5 M, preferably about 0.05 to 3 M, and more preferably about 0.1 to 1 M.

As the negative electrode releasing magnesium ions of the magnesium secondary cell of the present invention, it is possible to use metal magnesium; and as a negative electrode active material, it is possible to use magnesium alloy materials (e.g., Mg—In alloy, Mg—Zn alloy, Mg—Sn alloy, Mg—Cd alloy, Mg—Co alloy, Mg—Mn alloy, Mg—Ga alloy, Mg—Pb alloy, Mg—Ni alloy, Mg—Cu alloy, Mg—Al alloy, Mg—Ca alloy, Mg—Li alloy, Mg—Al—Zn alloy, and Mg—In—Ni), carbon materials (e.g., graphite, carbon fiber, amorphous carbon, and graphene), composite materials of metal magnesium or a magnesium alloy with a carbon material (e.g., magnesium alloy-graphite, metal magnesium-carbon fiber, magnesium alloy-carbon fiber, metal magnesium-amorphous carbon, and magnesium alloy-amorphous carbon), and the like.

As the positive electrode, a positive active material, such as a material in which magnesium ions undergo an insertion/extraction reaction, is used. Specific examples include magnesium-free metal sulfides, and magnesium-free metal oxides (e.g., TiS₂, MoS₂, NbSe₂, CoS, V₂O₅, V₈O₁₃, MnO₂, and CoO₂); oxides obtained by removing Li from Li-containing composite oxides, and replacing the Li with an Mg ion (e.g., MgMn₂O₄, MgAlO₃, MgMnO₃, MgFeO₃MgFe_{0.5}Mn_{0.5}O₃, MgFe_{0.9}Al_{0.1}O₃, MgMn_{0.9}Al_{0.1}O₃, Mg_{0.5}Mn_{0.9}Al_{0.1}O₂); Chevrel materials (Mo₆S₈, MₓMo₆S₈ (M=Cu, Ni, Ag, transition metal, 0≤x≤2), Cu_{0.13}Mg_{1.09-1.12}Mo₆S₈); polyanion materials (MgHf(MoO₄)₃, Mg_{0.5}Hf_{0.5}Sc_{1.0}(MoO₄)₃, Mg_{0.2}Zr_{0.2}Sc_{1.6}(WO₄)₃, Mg_{0.4}Zr_{0.4}Sc₁₋₂(WO₄)₃, Mg_{0.6}Zr_{0.6}Sc_{1.2}(WO₄)₃, Mg_{0.8}Zr_{0.8}Sc_{0.4}(WO₄)₃, MgZr(WO₄)₃); silicate materials (e.g., MgCoSiO₄, MgFeSiO₄, MgNiSiO₄, Mg(Ni_{0.9}Mn_{0.1})SiO₄, MgFe_{0.9}Si_{0.1}O₃, MgFe_{0.5}Si_{0.5}O₃, MgFe_{0.1}Si_{0.9}O₃, Mg_{1.023}(Mn_{0.956}V_{0.014}) SiO₄, FeF_{2.8}Cl_{0.2}MgCoSiO₄, MgMn_{0.9}Si_{0.1}O₃, Mg_{0.9925}(Co_{0.985}V_{0.015}) SiO₄, Mg_{0.959}(Fe_{0.918}V_{0.082})SiO₄, and Mg_{0.95}(Ni_{0.9}V_{0.100})SiO₄); magnesium nitride; organic positive-electrode materials (e.g., magnesium porphyrin, polythiophenes); compounds comprising transition metal and fluorine (e.g., FeF₃, MnF₃); halogenated compounds as a positive-electrode material; and the like.

The positive electrode is obtained by forming, on a collector, a positive-electrode-active-material layer containing a positive electrode active material, a binding agent, a conductive auxiliary agent, and the like.

The negative electrode may be metal magnesium, and is obtained by forming, on a collector, a negative-electrode-active-material layer containing a negative electrode active material, a binding agent, and the like.

Examples of binding agents used for the positive electrode and negative electrode include water-soluble polymers, such as polyimide, carboxymethyl cellulose, cellulose, diacetyl cellulose, methyl cellulose, hydroxyethyl cellulose, hydroxypropyl cellulose, sodium alginate, polyacrylic acid, sodium polyacrylate, polyvinyl phenol, polyvinyl methyl ether, polyvinyl alcohol, polyvinyl pyrrolidone, polyacrylonitrile, polyacrylamide, polyhydroxy(meth)acrylate, and styrene-maleic acid copolymer; emulsions (latexes), such as polyvinyl chloride, polytetrafluoroethylene, polyvinylidene fluoride (PVDF), tetrafluoroethylene-hexafluoropropylene copolymer, vinylidene fluoride-tetrafluoroethylene-hexafluoropropylene copolymers, polyethylene, polypropylene, ethylene-propylene-diene terpolymer (EPDM), sulfonated EPDM, polyvinyl acetal resin, (meth)acrylic acid ester-containing (meth)acrylic acid ester copolymers, e.g., methyl methacrylate and 2-ethylhexyl acrylate, vinyl ester-containing polyvinyl ester copolymers, e.g., (meth)acrylic acid ester-acrylonitrile copolymer and vinyl acetate, styrene-butadiene copolymers, acrylonitrile-butadiene copolymers, polybutadiene, neoprene rubber, fluororubber, polyethylene oxide, polyester-polyurethane resin, polyether-polyurethane resin, polycarbonate-polyurethane resin, polyester resin, phenol resin, and epoxy resin; and the like, with polyimide being preferable.

Examples of conductive auxiliary agents include vapor-grown carbon fiber (VGCF), Ketjen black (KB), carbon black, acetylene black, polyphenylene derivatives, and the like.

As a collector, it is preferable to use metal plates, such as aluminum, stainless steel, nickel, titanium, and the like. It is also preferable to use aluminum and stainless steel whose surface is covered with carbon, nickel, titanium, or silver; and alloys obtained by incorporating carbon, nickel, titanium, or silver into the surface of the aluminum or stainless steel.

As the coating liquid, for example, a slurry coating liquid may be used, optionally comprising a conductive auxiliary agent mentioned above, a binding agent mentioned above, and a dispersion medium, such as N-methyl-2-pyrrolidone (NMP), water, and toluene.

Examples of application methods include reverse roll coating, direct roll coating, blade coating, knife coating, extrusion coating, curtain coating, gravure coating, bar coating, dip coating, and squeeze coating. Of these, blade coating, knife coating, and extrusion coating are preferable. The application is preferably performed at a rate of 0.1 to 100 m/min. The application method may be selected from the above in view of the solution properties and drying properties of the coating liquid; in this way, it is possible to obtain an excellent surface state of the coating layer. The application of the coating liquid may be performed sequentially with respect to one surface at a time, or both surfaces simultaneously.

The electrolyte used in the present invention may further contain other electrolytes, such as a salt of TFSA with an alkali metal (e.g., Li, Na, K, and Cs).

The magnesium secondary cell of the present invention contains a separator and the like, in addition to the positive electrode, negative electrode, and nonaqueous electrolyte described above.

The electrolyte of the present invention is usually used by filling in or being impregnated into a separator and voids within an electrode.

Each constituent element described above is enclosed in various known cell casings, such as coin-type, cylinder-type, and laminate package; and sealed to obtain a magnesium secondary cell.

### EXAMPLES

The present invention is described in more detail below with reference to Examples and Comparative Examples. However, the present invention is not limited to these Examples.

In the Examples and Comparative Examples, the following abbreviations are used.

### DME: Dimethoxyethane

EiPSL or SL2i3: Ethyl isopropyl sulfone

### G1: Monoglyme

### G2: Diglyme

### G3: Triglyme

### G4: Tetraglyme

PC: Propylene carbonate

### AN: Acetonitrile

GBL: γ-butyrolactone

### SL12 or EMSL: Ethylmethylsulfone

SL33: Di-n-propylsulfone
SL44: Di-n-butylsulfone
WE: Working electrode
RE: Reference electrode
CE: Counter electrode

### Comparative Example 1

Using, as an electrolyte, a known single solvent (DME, EiPSL, G3, AN, or GBL) containing 0.5 M MgTFSA₂, a cyclic voltammetry measurement was conducted in an Ar-substituted glove box at room temperature under the following conditions.

WE: Pt flag (0.5 cm²)
CE: Mg ribbon (0.5 cm²)
RE: Ag wire (Quasi-reference electrode, hereinbelow abbreviated as Q.R.E.)
All electrodes are produced by Nilaco Co., Ltd., 3N or more
Container: Glass sample tube
At the time of solution preparation: Water content <50 ppm

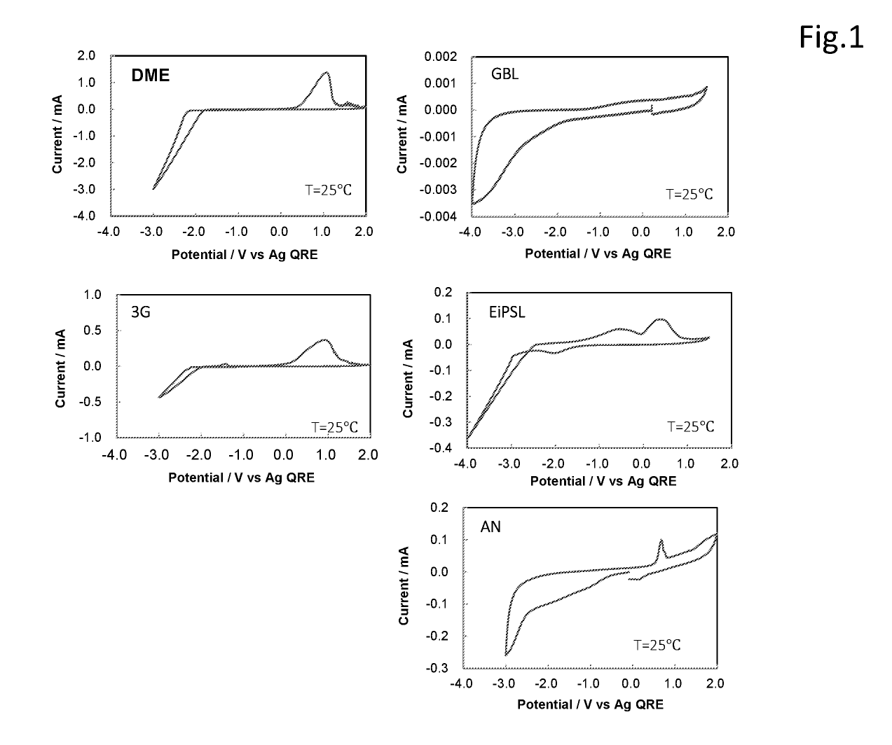

FIG. 1 shows the results. The results revealed that propylene carbonate (PC) or γ-butyrolactone (GBL) used for lithium-ion secondary cells did not show excellent redox, and therefore cannot be used at all. On the other hand, even in glymes (DME or G3) that have been reported to show relatively good redox, although the reduction current started flowing at a potential very close to the theoretical potential of Mg (−2.0 to −3.0 V vs Ag Q.R.E.) at room temperature, the subsequent oxidation peak rose in the vicinity of 0 to 1 V vs Ag Q.R.E., and a high overvoltage such as 2 V or more was observed during elution. This indicated that the known solvents had difficulty in operating as cells having at least a potential higher than the potential (1.5 V) of aqueous-based cells at room temperature.

### Comparative Example 2

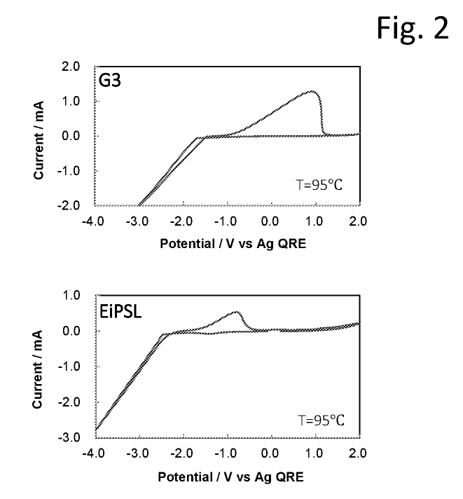

Using a known single solvent (G3 or EiPSL) containing 0.5 M MgTFSA₂ as a nonaqueous electrolyte, a cyclic voltammetry measurement was conducted at 95° C. in the same manner as in Comparative Example 1. FIG. 2 shows the results. It was confirmed that the overvoltage during elution was remarkably reduced by raising the temperature to 95° C. (T. Fukutsuka, K. Asaka, A. Inoo, R. Yasui, K. Miyazaki, T. Abe, K. Nishio, Y. Uchimoto, Chem. Lett., 43 (2014) 1788).

### Example 1

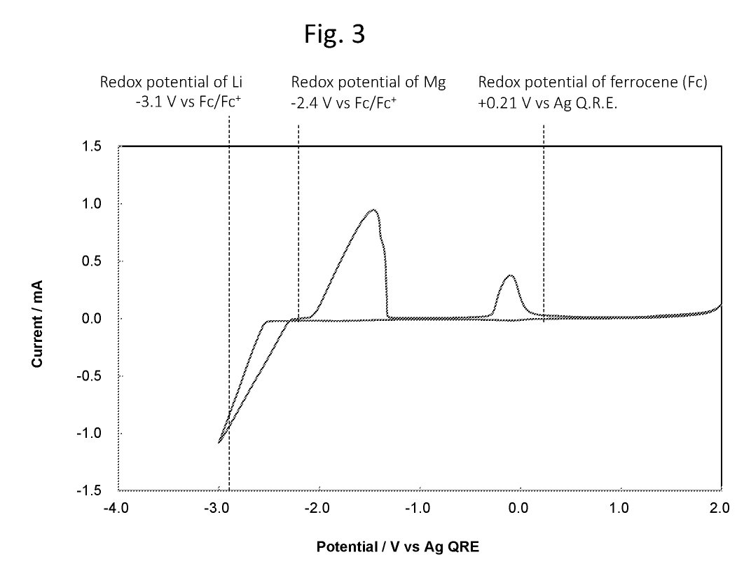

Using a mixed solvent solution of SL12:G3=1:1 containing 0.5 M MgTFSA₂ as a nonaqueous electrolyte, a cyclic voltammetry measurement was conducted at 25° C. in the same manner as in Comparative Example 1. FIG. 3 shows the results. To facilitate the comparison of potentials between different solvents or reference electrodes, the redox potential of ferrocene in the solvent used in the present invention was measured, which was +0.21 V vs Ag Q.R.E. Based on this, the large peak redox potential seen at −2.2 V vs Ag Q.R.E. was about −2.4 V vs Fc/Fc⁺, and this potential was found to be almost the same as the theoretical potential of Mg (the redox potential of Li is −3.1 V vs Fc/Fc⁺, and the potential difference between Li and Mg was 0.7 V; accordingly, the theoretical potential of Mg is −2.4 V vs Fc/Fc⁺). Further, since the rising potential of the oxidation current was +1.6 V vs Ag Q.R.E., the mixed solvent solution can be expected to apply to at least an Mg positive electrode material having a potential up to 4.2 V. According to the mixed solvent of the present invention, it was clarified that a clear redox peak at a potential in the vicinity of the theoretical potential of Mg can be obtained in a halogen-free electrolyte (with halogen, a high-voltage positive electrode cannot be used).

### Example 2

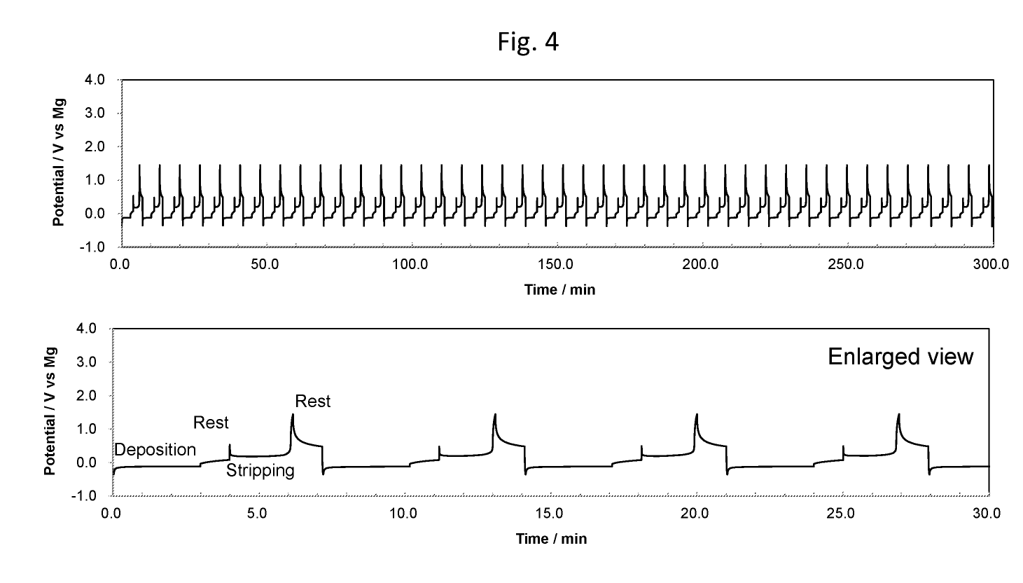

Using a mixed solvent of EMSL:G2=1:1 containing 0.5 M MgTFSA₂ as a nonaqueous electrolyte, a constant current deposition and re-elution test (working electrode: platinum, counter electrode: Mg metal, reference electrode: Ag wire) was conducted at 25° C. using a bio-logic VMP3 potentiostat (deposition or elution was performed at 20 μA for 3 minutes, and the recess between the deposition and elution was 1 minute). FIG. 4 shows the potential of the Pt working electrode to the Mg counter electrode versus time. It was clarified from FIG. 4 that deposition and re-elution continuously occurred on platinum over at least 5 hours.

### Example 3

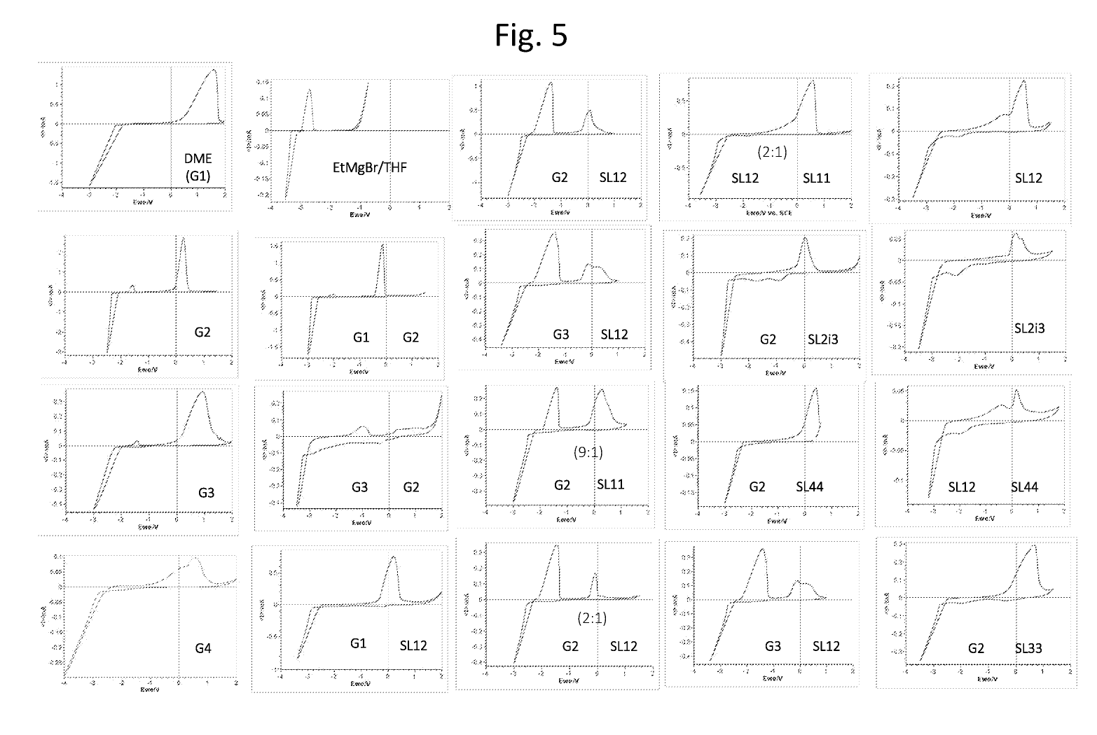

FIG. 5 shows a cyclic voltammogram obtained when different kinds of solvents were mixed in a molar ratio of 1:1 (the ratio is defined only when the ratio is other than 1:1). FIG. 5 reveals the following. Excellent results were obtained only when completely different solvents (glymes and sulfones) were mixed. The mixture of different glymes (e.g., G2 and G3) or the mixture of different sulfones (e.g., SL11 and SL12) did not attain the excellent results that were obtained when G2 and SL12 or G3 and SL12 are mixed. By changing the mixing molar ratio of G2 and SL12 from 1:1, the peak in the vicinity of 0 V vs Ag Q.R.E. became smaller. This suggests that the mixing ratio can be optimized.

### Example 4

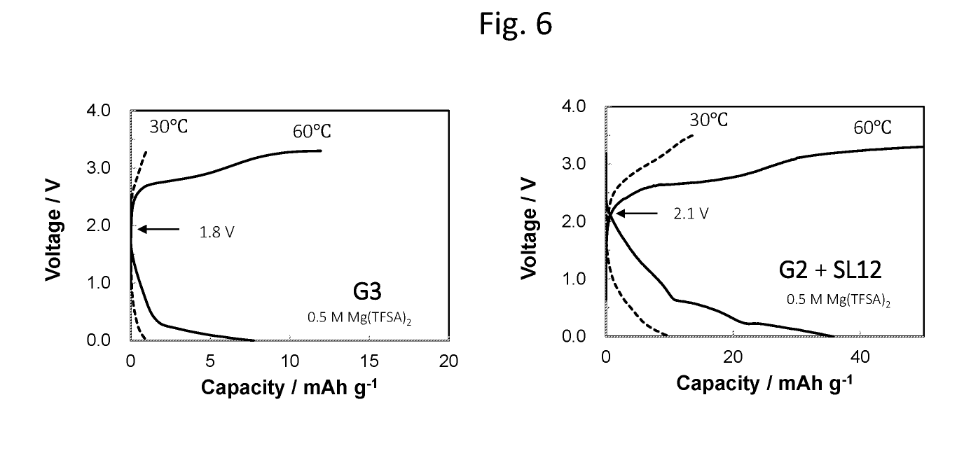

A positive mixture obtained according to the following method from V₂O₅, in which occurrence of insertion and extraction of Mg has been mentioned, was used as a positive electrode; and a less expensive and easily handled Mg alloy (AZ31), which can be obtained as a foil and treated in a manner similar to that of Mg metal, was used in place of Mg metal as a negative electrode to form a coin cell (CR2032). A charge-discharge measurement was then performed, and the results obtained thereby are shown in FIG. 6.

The following positive active material, binding agent, and conductive auxiliary agent were mixed in a solvent (N-methylpyrrolidone) to obtain a paste. The paste was applied to a collector and dried, thus obtaining a positive electrode. The positive electrode was a sheet having a diameter of 16 mm, wherein the active material weight was about 1.5 mg, and the thickness was about 15 μm.

Positive active material: V₂O₅ 90 wt %
Binding agent: Polyimide (PI) 5 wt %
Conductive auxiliary agent: Vapor-grown carbon fiber (VGCF)₂ wt %
Ketjen black (KB) 3 wt %
Collector: Aluminum foil

The previously mentioned G3 did not work at all at room temperature, and showed a capacity of barely 7 mAh/g at 60° C. On the other hand, the electrolyte of the present invention showed a capacity of 35 mAh/g at 60° C., which was 5 times larger than that of G3, and increased the average voltage from 1.8 V (G3) to 2.1 V. This was because, as shown in FIG. 4, smooth deposition and re-elution occurred on Mg, and the overvoltage was kept low on Mg. This capacity is smaller than the theoretical capacity (about 295 mAh/g) of V₂O₅. This is because the V₂O₅ electrode currently used is not necessarily an optimum electrode.

1. A magnesium secondary cell comprising a positive electrode, a negative electrode releasing magnesium ions, and a nonaqueous electrolyte,
the nonaqueous electrolyte comprising a solvent and a magnesium sulfonamide salt represented by formula (I):
Mg[X¹—SO₂—N—SO₂—X²]₂ (I)
wherein X¹ and X² are identical or different and each represents CₚF₂ₚ₊₁, or X¹ and X² are taken together to represent C_{q}F_{2q}, wherein p is 0, 1, 2, or 3, and q is 2, 3, or 4,
the solvent being a mixed solvent comprising a sulfone-based solvent and an ether- or thioether-based solvent, or the solvent being a solvent comprising a sulfone moiety and an ether or thioether moiety.

2. The magnesium secondary cell according to claim 1, wherein the sulfone-based solvent is represented by formula (II): 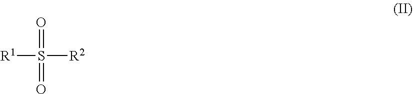
wherein R¹ and R² are identical or different and each represents a C₁₋₄ alkyl group.

3. The magnesium secondary cell according to claim 1, wherein the ether- or thioether-based solvent is represented by formula (III): 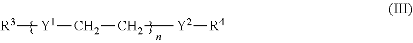
wherein Y¹ and Y² are identical or different and each represents O or S, R³ and R⁴ are identical or different and each represents methyl or ethyl, and n is an integer of 1 to 4.

4. The magnesium secondary cell according to claim 1, wherein the solvent comprising a sulfone moiety and an ether or thioether moiety is represented by formula (IV): 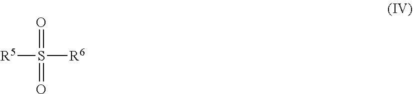
wherein R⁵ and R⁶ are identical or different and both represent a group represented by —R⁷—(O—CH₂CH₂—)ₘ—OR⁸—, or one represents a C₁₋₄ alkyl group and the other represents a group represented by R⁷—(O—CH₂CH₂—)ₘ—OR⁸, wherein m is an integer of 0 to 2, R⁷ represents CH₂ or CH₂CH₂, and R⁸ represents methyl or ethyl.

5. A nonaqueous electrolyte for magnesium secondary cells comprising (a) a mixed solvent comprising a sulfone-based solvent and an ether- or thioether-based solvent, or a solvent comprising a sulfone moiety and an ether or thioether moiety and (b) a magnesium sulfonamide salt represented by formula (I):
Mg[X¹—SO₂—N—SO₂—X²]₂ (I)
wherein X¹ and X² are identical or different and each represents CₚF₂ₚ₊₁, or X¹ and X² are taken together to represent C_{q}F_{2q}, wherein p is 0, 1, 2, or 3, and q is 2, 3, or 4.

6. The magnesium secondary cell according to claim 1, wherein the solvent is
(i) a mixed solvent comprising
a sulfone-based solvent represented by formula (II): 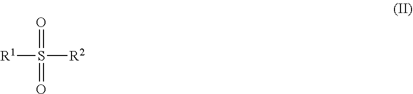
wherein R¹ and R² are identical or different and each represents a C₁₋₄ alkyl group, and
an ether- or thioether-based solvent represented by formula (III): 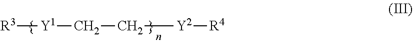
wherein Y¹ and Y² are identical or different and each represents O or S, R³ and R⁴ are identical or different and each represents methyl or ethyl, and n is an integer of 1 to 4, or
(ii) a solvent comprising a sulfone moiety and an ether or thioether moiety represented by formula (IV): 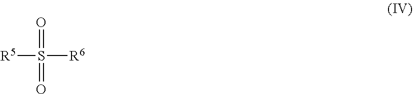
wherein R⁵ and R⁶ are identical or different and both represent a group represented by —R⁷—(O—CH₂CH₂—)ₘ—OR⁸—, or one represents a C₁₋₄ alkyl group and the other represents a group represented by R⁷—(O—CH₂CH₂—)ₘ—OR⁸, wherein m is an integer of 0 to 2, R⁷ represents CH₂ or CH₂CH₂, and R⁸ represents methyl or ethyl.

7. The magnesium secondary cell according to claim 1, wherein the solvent is a mixed solvent of glycol dimethyl ether (diglyme, G2) or triethylene glycol dimethyl ether (triglyme, G3), and ethylmethylsulfone.

8. The magnesium secondary cell according to claim 1, wherein the nonaqueous electrolyte is free of halides.

9. A nonaqueous electrolyte according to claim 5, comprising
(i) a mixed solvent comprising a sulfone-based solvent and an ether- or thioether-based solvent a mixed solvent, wherein the sulfone-based solvent is represented by formula (II): 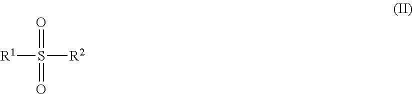
wherein R¹ and R² are identical or different and each represents a C₁₋₄ alkyl group, and
wherein the ether- or thioether-based solvent is represented by formula (III): 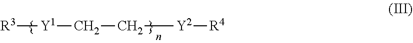
wherein Y¹ and Y² are identical or different and each represents O or S, R³ and R⁴ are identical or different and each represents methyl or ethyl, and n is an integer of 1 to 4, or
(ii) a solvent comprising a sulfone moiety and an ether or thioether moiety represented by formula (IV): 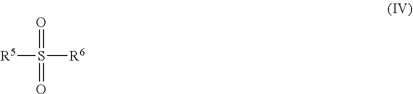
wherein R⁵ and R⁶ are identical or different and both represent a group represented by —R⁷—(O—CH₂CH₂—)ₘ—OR⁸, or one represents a C₁₋₄ alkyl group and the other represents a group represented by R⁷—(O—CH₂CH₂—)ₘ—OR⁸, wherein m is an integer of 0 to 2, R⁷ represents CH₂ or CH₂CH₂, and R⁸ represents methyl or ethyl.

10. The nonaqueous electrolyte according to claim 5, wherein the mixed solvent is a mixed solvent of glycol dimethyl ether (diglyme, G2) or triethylene glycol dimethyl ether (triglyme, G3), and ethylmethylsulfone.

11. The nonaqueous electrolyte according to claim 5, wherein the nonaqueous electrolyte is free of halides.
